(19) United States
(12) Patent Application Publication
(10) Pub. No.: US 2009/0060245 A1
(43) Pub. Date: Mar. 5, 2009

(54) Balanced armature with acoustic low pass filter

(76) Inventors: Mark Alan Blanchard, Lebanon, IN (US); Bradley Carl Geswein, Plainfield, IN (US); Eric A. Hruza, Plymouth, MN (US); Onno Geschiere, Amsterdam (NL)

Correspondence Address: KRIEG DEVAULT LLP, ONE INDIANA SQUARE, SUITE 2800, INDIANAPOLIS, IN, 46204-2079, US

(21) Appl. No.: 11/897,380

(22) Filed: Aug. 30, 2007

(51) Int. Cl. H04R 1/02; H04R 1/20; H04R 25/00

(52) U.S. Cl. 381/345; 381/354; 381/380

(57) ABSTRACT

A balanced armature apparatus is disclosed that includes dual transducers for generating sound waves in response to electric audio signals. The dual transducers include a motor assembly coupled to a diaphragm. A housing defines an interior chamber and the motor assembly and the diaphragm are positioned within the interior chamber. A pair of acoustic output ports is located in a respective end of the housing. A low pass acoustic filter is in communication with one of the acoustic output ports that is operable to attenuate a predetermined range of frequencies from an audio signal produced by one of the diaphragms.

### BACKGROUND

The present invention relates to balanced armatures for playback of audio in headphones, stethoscopes, peritympanic hearing instruments or hearing aids, and headsets, and more particularly to “in ear” applications where the ear tip comes in contact with an ear canal wall.

A balanced armature is an electro-acoustic transducer which converts energy from electrical energy to acoustical energy. Balanced armatures have certain electro-acoustical limitations where nonlinearity of the flux field and armature due to saturation create distortion at the output. Mechanical compliance is also limited which can further induce distortion. Limitations also exist in the frequency bandwidth of the design. The armature has natural resonant frequencies from mass and compliance relationships that can impede smooth frequency response. Depending on the resonant frequency of the armature, the design will be deficient in the low frequency and/or high frequency region of the response.

### SUMMARY

One embodiment of the present application discloses a balanced armature speaker including dual transducers and a low pass filter associated with an acoustical output. Other embodiments include unique apparatus, devices, systems, and methods of providing a balanced armature speaker that includes tuned armatures and a low pass filter. Further embodiments, forms, objects, features, advantages, aspects, and benefits of the present application shall become apparent from the detailed description and figures included herewith.

### BRIEF DESCRIPTION OF THE DRAWINGS

The figures are not necessarily to scale, emphasis instead being placed upon illustrating the principles of the invention. Moreover, in the figures, like reference numerals designate corresponding parts throughout the different views.

FIG. 1 is a perspective view of an illustrative balanced armature speaker.

FIG. 2 is a front view of the balanced armature speaker depicted in FIG. 1.

FIG. 3 is a cross-sectional view of the balanced armature speaker depicted in FIG. 2 along axis A-A.

FIG. 4 is a cutaway view of another representative balanced armature speaker.

FIG. 5 illustrates an in ear audio system including a passive crossover connected with the balanced armature speaker disclosed in FIG. 4.

FIG. 6 illustrates an in ear audio system including an active analog crossover connected with the balanced armature speaker disclosed in FIG. 4.

FIG. 7 illustrates an in ear audio system including an active digital crossover connected with the balanced armature speaker disclosed in FIG. 4.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention is illustrated therein being contemplated as would normally occur to one skilled in the art to which the invention relates.

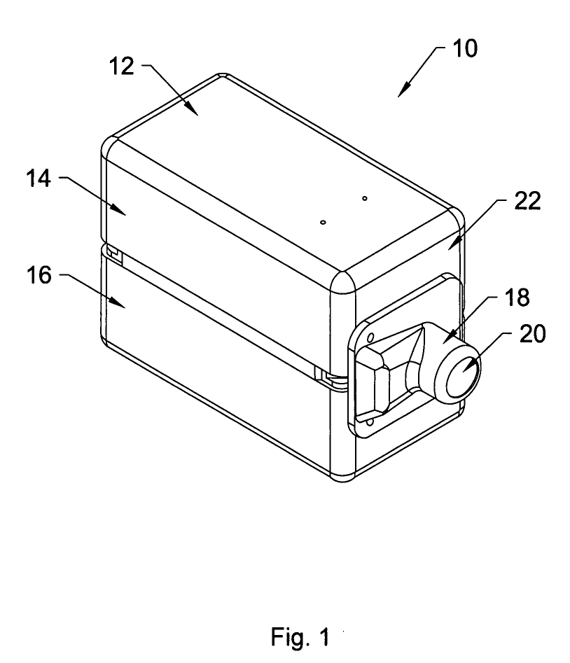

Referring to FIG. 1, a balanced armature speaker 10 is illustrated that is operable to convert an electrical input audio signal into an acoustic output signal. A housing 12 surrounds or houses the working components of balanced armature speaker 10 and includes a first segment or portion 14 and a second segment or portion 16. As illustrated, first portion 14 of housing 12 is connected to second portion 16 of housing 12. In one form, first portion 14 is welded to second portion 16, but alternative connection methods may be used, similar to welding. In one form, as set forth in detail below, first portion 14 houses working components operable to optimally produce sound waves falling in the mid-range and high range of the audio frequency spectrum (i.e., 300 Hz-20,000 Hz). Second portion 16 houses working components operable to optimally produce sound waves falling in the bass range of the audio frequency spectrum (i.e., 20 Hz-300 Hz).

Balanced armature speaker 10 includes a spout 18 where an acoustic output signal is broadcast from an output port 20 of spout 18. As illustrated, at least a portion of output port 20 of spout 18 comprises a tubular shaped member. As set forth in greater detail below, internal working components of balanced armature speaker 10 receive electrical audio input signals that are converted by the internal working components to an acoustic output signal that is broadcast or emitted from output port 20 of spout 18. Spout 18 is connected with a respective end 22 of housing 12. In one form, spout 18 is welded to the end 22 of housing 12, but other methods of connecting spout 18 to end 22 of housing 12 are envisioned and hereby incorporated. In another representative form, spout 18 may be formed as an integral part of housing 12.

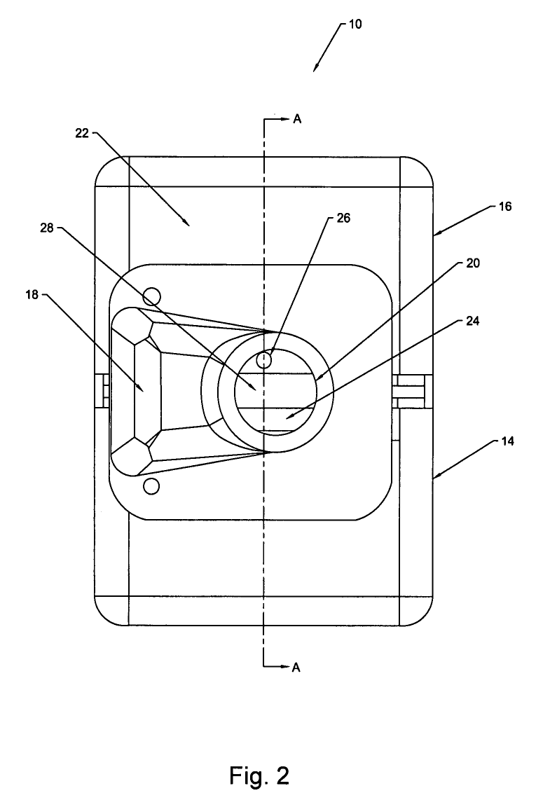

Referring to FIG. 2, a front view of balanced armature speaker 10 illustrated in FIG. 1 is set forth. Spout 18 of balanced armature speaker 10 includes an output port 20 for broadcasting or emitting acoustic output signals or sound waves. In one form, output port 20 includes a high frequency output port 24 and a low frequency output port 26. Low frequency output port 26 comprises an acoustic low pass filter. As such, low frequency output port 26 is operable to pass certain low frequency signals but attenuate (i.e.—reduces the amplitude on signals with frequencies higher than a predetermined cutoff frequency.

Since low frequency output port 26 functions as a low pass filter, low frequency output port 26 is referred to hereinafter as low pass filter 26. As set forth above, low pass filter 26 passes low frequency signals falling within a predetermined range and attenuates or removes frequency signals falling above a predetermined threshold or cutoff frequency. As illustrated in FIG. 2, in one form low pass filter 26 comprises a generally circular shaped aperture. In one illustrative form, the generally circular shaped aperture has a predetermined diameter of about 0.2 millimeters to 0.3 millimeters.

As illustrated in FIG. 2, in one form, high frequency output port 24 comprises a generally rectangular shaped aperture or slit. A support member or barrier 28 separates low pass filter 26 from high frequency output port 24 and creates a seal between end 22 of housing 12 and spout 18. In this form, low pass filter 26 and high frequency output port 24 are located in spout 18. As such, sound waves generated from the working components contained within first portion 14 of housing 12 are broadcasted or emitted through high frequency output port 24 of spout 18. Likewise, sound waves generated from the working components contained within second portion 16 of housing 12 are broadcast or emitted through low pass filter 26.

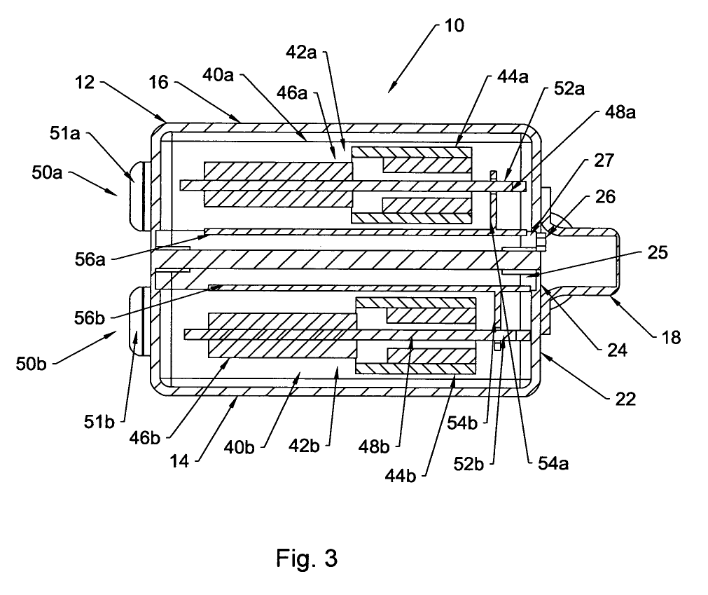

Referring to FIG. 3, a cross-sectional view of balanced armature speaker 10 along axis A-A as depicted in FIG. 2 is illustrated. As illustrated, in this form, low pass filter 26 is formed in respective end 22 of housing 12. Low pass filter 26 is in communication with an output port 27 in housing 12. In addition, high frequency output port 24 is formed in respective end 22 of housing 12. High frequency output port 24 is in communication with a second output port 25 in housing 12. As such, low pass filter 26 and high frequency output port 24 can be formed in either spout 18 or end 22 of housing 12. In one form, low pass filter 26 has a predetermined width or depth of about 0.3 millimeters in housing 12. In addition, in one form high frequency output port 24 has a predetermined width or depth of about 2.5 millimeters in housing 12.

Balanced armature speaker 10 includes a pair of transducers 40a, 40b mounted or secured in housing 12 in a side-by-side alignment or arrangement. Transducers 40a, 40b each include a motor 42a, 42b that includes a magnet assembly 44a, 44b and a coil assembly 46a, 46b that are coaxially aligned with one another and in a generally side-by-side alignment in housing 12. Located through an axial center of each coil assembly 46a, 46b and magnet assembly 44a, 44b is a movable armature 48a, 48b. Armatures 48a, 48b are located within coil assembly 46a, 46b and magnet assembly 44a, 44b such that armatures 48a, 48b do not touch either component, thereby allow free movement of armatures 48a, 48b. Armatures 48a, 48b are moveable in response to electromagnetic forces produced by the magnet assembly 44a, 44b and coil assembly 46a, 46b in response to audio frequency electric signals applied to an electrical connector assembly 50a, 50b connected with each respective transducer 40a, 40b. It should be appreciated that each electrical connector assembly 50a, 50b includes two electrical connectors 51a, 51b. As such, first portion 14 of housing 12 includes two electrical connectors 51b and second portion 16 of housing 12 includes two electrical connectors 51a.

A respective end 52a, 52b of each armature 48a, 48b protrudes outwardly from magnet assemblies 44a, 44b. A drive pin 54a, 54b is connected with end 52a, 52b of each armature 48a, 48b. Each drive pin 54a, 54b is connected with a diaphragm or membrane 56a, 56b. As previously set forth, armatures 48a, 48b move in response to electrical audio signals received from electrical connector assemblies 50a, 50b. The corresponding movement of armatures 48a, 48b is translated into acoustic energy or sound waves by diaphragms 56a, 56b. Diaphragms 56a, 56b are mounted in a free air space in the housing 12 above magnet assembly 44a, 44b and coil assembly 46a, 46b and are operatively coupled to each respective armature 48a, 48b by drive pins 54a, 54b. Respective outer ends or edges of diaphragms 56a, 56b are connected interior portions of first portion 14 of housing 12 and second portion 16 of housing 12

In one form, the shape and configuration of armature 48a is optimized for the production of low or bass frequencies and armature 48b is optimized for the production of high and mid-range frequencies. As such, armature 48a is optimized for producing frequencies falling in the bass region of the audio spectrum and is associated with an output 27 in housing 12 in communication with low pass filter 26. As such, armature 48a is specifically tuned to a low pass frequency response. Armature 48b is optimized for maintaining the primary resonance of armature 48b for producing a broad band of frequencies falling above the bass region of the audio spectrum. Armature 48b is associated with an output 25 in housing 12 in communication with high frequency output port 24. In another form, armatures 48a, 48b have a similar configuration but balanced armature speaker 10 includes high frequency output port 24 and low pass filter 26.

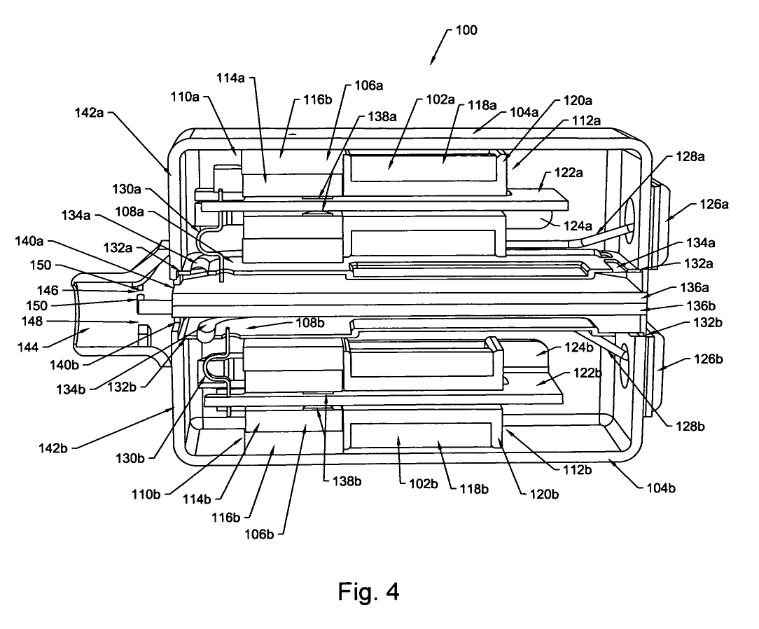

Referring to FIG. 4, a cutaway view of another representative form of a balanced armature speaker 100 is illustrated. Balanced armature speaker 100 includes a pair of transducers 102a, 102b housed within a pair of housings 104a, 104b. Each transducer 102a, 102b includes a motor 106a, 106b that is used to vibrate diaphragms or membranes 108a, 108b so that diaphragms 108a, 108b can produce sound waves. Motors 106a, 106b include a magnet assembly 110a, 110b and a coil assembly 112a,112b. Magnet assemblies 110a, 110b and coil assemblies 112a, 112b are coaxially located and in a side-by-side abutting alignment in housings 104a, 104b.

Magnet assemblies 110a, 110b include a magnet 114a, 114b that is surrounded by a magnet shell 116a, 116b. Magnet shells 116a, 116b are connected with interior surfaces of housings 104a, 104b and magnets 114a, 114b are connected with magnet shells 116a, 116b. Coil assemblies 112a, 112b include a coil winding 118a, 118b that is wrapped around a bobbin 120a, 120b. Positioned through an axial center of magnets 114a, 114b and coil windings 118a, 118b is a moveable armature 122a, 122b. Armatures 122a, 122b include a base portion 124a, 124b that is connected with a surface of housings 104a, 104b. Armatures 122a, 122b are positioned through magnets 114a, 114b and coil windings 118a, 118b such that an upper and lower gap exists between respective surfaces of magnets 114a, 114b and coil windings 118a, 118b.

A portion of bobbins 120a, 120b is connected with respective base portions 124a, 124b of armatures 122a, 122b. Base portions 124a, 124b are connected with an interior surface of housings 104a, 104b. Electrical connector assemblies 126a, 126b, which are located on an outside surface of housings 104a, 104b, are connected to coil windings 118a, 118b by a wire connection 128a, 128b running inside housings 104a, 104b. An end of armatures 122a, 122b that extend from magnet assemblies 110a, 110b include a drive pin 130a, 130b that extends upwardly and is connected with a respective end of each diaphragm 108a, 108b.

Electrical connector assemblies 126a, 126b receive respective input audio frequency electrical signals that are converted into acoustic energy in the form of sound waves by movement of armatures 122a, 122b, which thereby causes vibration of diaphragms 108a, 108b. As illustrated, outside edges of the diaphragms 108a, 108b are connected with a lip 132a, 132b extending inwardly from an inside surface of housings 104a, 104b. Diaphragms 108a, 108b may be connected with lips 132a, 132b using one of several different kinds of adhesives or some other suitable material or device. Diaphragms 108a, 108b include a flexible foil 134a, 134b that runs around portions of an outside edge of diaphragms 108a, 108b. Flexible foils 134a, 134b allow diaphragms 108a, 108b to freely move back and forth in response to movement of drive pins 130a, 130b.

As previously set forth, in response to respective audio frequency electrical signals applied to electrical connector assemblies 126a, 126b, armatures 122a, 122b move in response electromagnetic forces produced by magnet assemblies 110a, 110b and coil assemblies 112a, 112b. As such, the corresponding motion of armatures 122a, 122b is translated into acoustic energy or sound waves by diaphragms 108a, 108b which are mounted in housings 104a, 104b above magnet assemblies 110a, 110b and coil assemblies 112a, 112b and are operatively coupled with armatures 122a, 122b by drive pins 130a, 130b. Sufficient free airspace exists between diaphragms 108a, 108b, upper covers 136a, 136b, magnetic assemblies 110a, 110b, and coil assemblies 112a, 112b to permit vibration of diaphragms 108a, 108b to create acoustic energy or sound waves in response to operation of armatures 122a, 122b.

As illustrated in FIG. 4, cover 136a is connected with housing 104a and cover 136b is connected with housing 104b. Cover 136a is connected with cover 136b to form a single unitary housing. In addition, covers 136a, 136b acoustically seal first transducer 102a from second transducer 102b. As such, covers 136a, 136b act as an acoustic barrier or divider between transducers 102a, 102b. Shock plates 138a, 138b may be connected to interior surfaces of magnets 114a, 114b to prevent armatures 122a, 122b from coming into contact with magnets 114a, 114b.

In one form, acoustic output ports 140a, 140b are located in a respective end 142a, 142b of housings 104a, 104b. Acoustic energy or sound waves generated by vibration of diaphragms 108a, 108b are broadcast or emitted from acoustic output ports 140a, 140b. A spout 144 is connected with ends 142a, 142b of housings 104a, 104b. As previously set forth, spout 144 may be welded to housings 104a, 104b or connected using any other suitable connection method or device.

As indicated above with respect to the description of the embodiment set forth in FIG. 2, in one form spout 144 includes a low pass filter 146 and a high frequency output port 148. In another form, low pass filter 146 and high frequency output port 148 are positioned in respective ends 142a, 142b of housings 104a, 104b. Transducer 102a is optimized to produce low frequency audio outputs or sound waves and transducer 102b is optimized to produce high frequency audio outputs or sound waves. Spout 144 includes a constriction plate 150 that includes low pass filter 146. As previously set forth, low pass filter 146 comprises a generally circular shaped aperture.

As set forth above, the generally circular shaped aperture or low pass filter 146 is located in constriction plate 150. Low pass filter 146 is formed because the aperture increases the resistance of the air. One benefit of the present invention is improved acoustic performance in the bass region of the audio spectrum without the requirement of sacrificing high frequency integrity. As previously set forth, armature 122a, which can be viewed as the woofer side of balanced armature speaker 100, is tuned to a low pass frequency response.

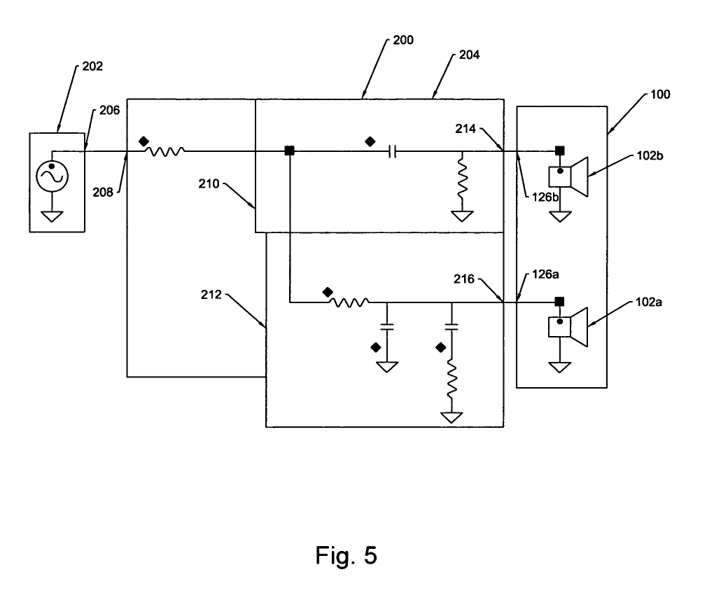

Referring to FIG. 5, an in ear audio system 200 is illustrated that includes balanced armature speaker 100. In ear audio system 200 includes an analog audio signal source 202 and a passive crossover 204. An output 206 of analog audio signal source 202 is connected with an input 208 of passive crossover 204. Passive crossover 204 includes a high pass filter 210 and a low pass filter 212. High pass filter 210 ignores, or passes frequencies above a predetermined frequency and attenuates, or rolls off, frequencies below the predetermined frequency. For example, in one form, high pass filter 210 is configured to pass frequencies above 300 Hz and attenuate or roll off frequencies below 300 Hz. Low pass filter 212 passes frequencies below a predetermined frequency and attenuates frequencies above it. For example, in one form, low pass filter 212 is configured to pass frequencies below 300 Hz and attenuate or rolls off frequencies above 300 Hz.

As illustrated, passive crossover 204 is configured to divide an electric audio signal that is generated by analog audio signal source 202 into two separate electric audio signals. A first electric audio signal is directed or transmitted to high pass filter 210 and a second audio signal is directed or transmitted to low pass filter 212. Once high pass filter 210 attenuates the first electric audio signal, the first electric audio signal is directed to balanced armature speaker 100. At the same time, low pass filter 212 attenuates the second electric audio signal and directs it to balanced armature speaker 100.

As illustrated, high pass filter 210 includes a high pass output 214 that is connected to electrical connector assembly 126b of balanced armature speaker 100. As such, the attenuated electric audio signal, having low frequencies attenuated or removed, is sent to transducer 102b. Low pass filter 212 includes a low pass output 216 that is connected to electrical connector assembly 126a of balanced armature speaker 100. The attenuated electric audio signal, having high frequencies attenuated or removed, is sent to transducer 102a. The use of passive crossover 200 allows balanced armature speaker 100 to further produce a better quality sound as a result of the attenuation that occurs before electric audio signals are supplied to electrical connector assemblies 126a, 126b.

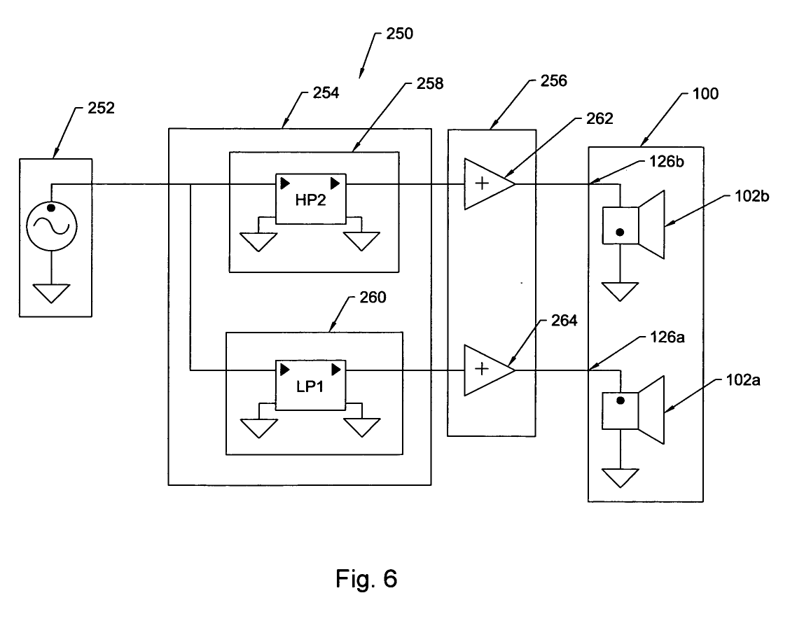

Referring to FIG. 6, another representative in ear audio system 250 is illustrated that includes balanced armature speaker 100. In this form, in ear audio system 250 includes an analog audio signal source 252, an analog active crossover 254, and an amplification stage 256. An output of analog audio signal source 252 is connected with analog active crossover 254 which has outputs that are, in turn, connected with inputs of amplification stage 256. An electric audio signal output of analog audio signal source 252 is communicated to analog active crossover 254. The output of amplification stage 256 is connected directly to the balanced armature speaker 100. Amplification stage 256 presents the maximum damping factor at all times, regardless of frequency, and is not affected by active crossover 254, since that is also active, and located before amplification stage 256.

As illustrated, analog audio signal output from source 252 is provided to active crossover 254. The electric audio signal output is provided as an input to a high pass filter circuit 258 and a low pass filter circuit 260. High pass filter circuit 258 is designed and configured to attenuate or roll off frequencies below a predetermined threshold (e.g. −300 Hz). Low pass filter circuit 260 attenuates or rolls off frequencies above a predetermined threshold (e.g. −300 Hz).

A first electric audio signal output, that has been filtered by high pass filter 258, is supplied to a first amplifier 262 of amplification stage 256. A second electric audio signal output, that has been filtered by low pass filter 260, is supplied to a second amplifier 264 of amplification stage 256. A first amplified electric audio signal is supplied, via electrical connector assembly 126b, from an output of first amplifier 262 to transducer 102b of balanced armature speaker 100. A second amplified electric audio signal is supplied, via electrical connector assembly 126a, from an output of second amplifier 264 to transducer 102a of balanced armature speaker 100.

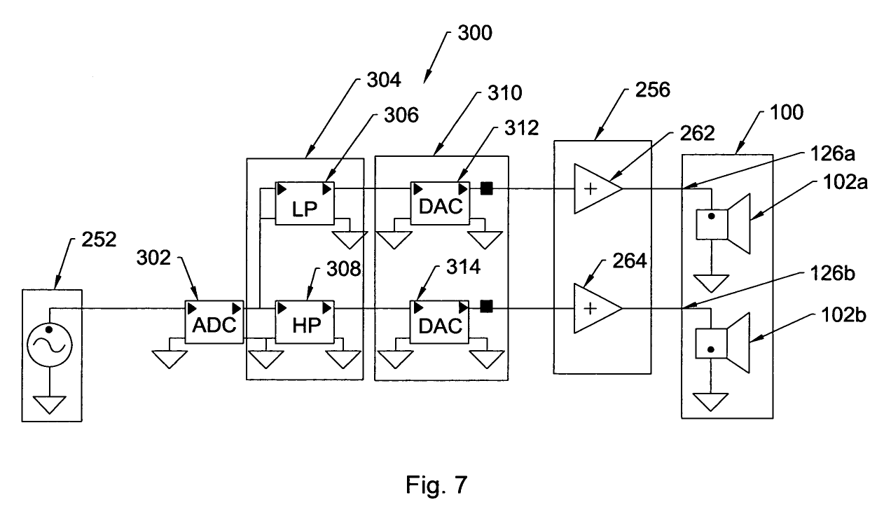

Referring to FIG. 7, yet another in ear audio system 300 is illustrated that includes balanced armature speaker 100. As with the previous form set forth in FIG. 6, this system 300 also includes an analog audio signal source 252. Source 252 is connected with an analog to digital converter 302 that converts the analog audio signal provided by source 252 into a digital audio signal. The digital audio signal is then communicated to a digital active crossover 304. In one form, digital active crossover 304 comprises a finite impulse response (“FIR”) crossover and in another representative form digital active crossover 304 comprises an infinite impulse response (“IIR”) crossover.

Digital active crossover 304 divides the digital audio signal into two signals that are supplied as inputs to a digital low pass filter 306 and a digital high pass filter 308. Digital low pass filter 306 attenuates or removes frequencies falling above a predetermined threshold and digital high pass filter 308 attenuates or removes frequencies falling below a predetermined threshold. The outputs of digital low pass filter 306 and digital high pass filter 308 are supplied as inputs to a digital to analog conversion stage 310 that includes a first and second digital to analog converter 312, 314.

First digital to analog converter 312 converts filtered digital audio signals that are generated by digital low pass filter 306 into filtered analog audio signals. Second digital to analog converter 314 converts filtered digital audio signals that are generated by digital high pass filter 308 into filtered analog audio signals. These respective filtered analog audio signals are supplied as inputs to amplifiers 262, 264 of amplification stage 256. As with the previous form illustrated in FIG. 6, amplified analog audio output signals from amplifiers 262, 264 are supplied to transducers 102a, 102b of balanced armature speaker 100.

One form of the present invention discloses an apparatus that includes a motor assembly coupled to a diaphragm. The apparatus also includes a housing defining an interior chamber. The motor assembly and the diaphragm are positioned within the interior chamber. An acoustic output port is located in a respective end of the housing. A low pass acoustic filter is in communication with the acoustic output port that is operable to attenuate a predetermined range of frequencies from an audio signal or sound wave produced by the diaphragm.

Another from of the present invention discloses a balanced armature speaker comprising a motor comprising a coil and a magnet assembly; an armature extending through the coil and the magnet assembly; a drive pin having one end coupled to the armature and a second end coupled to a membrane; a housing containing the motor, the armature, the drive pin and the membrane; and a spout coupled to a respective end of the housing including a low pass filter.

In yet another form, an apparatus is disclosed comprising a first transducer positioned in a housing; a second transducer positioned in the housing such that the first and second transducers are oriented in a side-by-side relation in the housing; a dividing member separating the first and second transducers such that the first and second transducers are substantially isolated from one another; a spout connected to a respective end of the housing; a first output port in the housing for directing sound waves generated by the first transducer through an output of the spout; and a second output port in the housing for directing sound waves generated by the second transducer through a low pass filter and then out of the spout.

Another embodiment discloses a method comprising generating sound waves from a first transducer positioned in a housing; generating sound waves from a second transducer positioned in the housing; directing the sound waves generated by the first transducer to an output port located in a spout; and directing the sounds waves generated by the second transducer to a low pass filter located in the spout.

A further aspect of the present invention discloses an apparatus comprising a housing; a first motor assembly coupled to a first diaphragm positioned in a first side of the housing; a second motor assembly coupled to a second diaphragm positioned in a second side of the housing; a cover separating the first motor assembly and the first diaphragm from the second motor assembly and the second diaphragm; a first acoustic output port located in the housing for directing sound waves generated from operation of the first diaphragm out of the housing; a second acoustic output port located in the housing for directing sound waves generated from operation of the second diaphragm out of the housing; and a filter in communication with the first acoustic output port for attenuating a predetermined range of frequencies from the sound waves generated by operation of the first diaphragm.

Another aspect of the present invention discloses an in ear audio system comprising an electric audio signal source for producing an electric audio signal; a crossover connected with the electric audio signal source including a low pass filter and a high pass filter; a balanced armature speaker connected with a first output of the low pass filter and a second output from the high pass filter; and wherein the balanced armature speaker includes a motor assembly coupled to a diaphragm; a housing defining an interior chamber, wherein the motor assembly and the diaphragm are positioned within the interior chamber; an acoustic output port located in a respective end of the housing; and a low pass acoustic filter in communication with the acoustic output port operable to attenuate a predetermined range of frequencies from an audio signal produced by the diaphragm.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus, comprising:
a motor assembly coupled to a diaphragm;
a housing defining an interior chamber, wherein said motor assembly and said diaphragm are positioned within said interior chamber;
an acoustic output port located in a respective end of said housing; and
a low pass acoustic filter in communication with said acoustic output port operable to attenuate a predetermined range of frequencies from an audio signal produced by said diaphragm.

2. The apparatus of claim 1, wherein said low pass acoustic filter comprises an aperture formed in said housing.

3. The apparatus of claim 2, wherein said aperture comprises a generally circular shaped aperture having a predetermined width and diameter.

4. The apparatus of claim 1, further comprising a spout connected with an outside surface of said housing.

5. The apparatus of claim 4, wherein said low pass acoustic filter comprises an aperture in said spout.

6. The apparatus of claim 5, wherein said aperture comprises a generally circular shaped aperture having a predetermined width and diameter.

7. The apparatus of claim 6, wherein said predetermined width is about 0.3 millimeters.

8. The apparatus of claim 6, wherein said predetermined diameter is between about 0.2 millimeters to 0.3 millimeters.

9. A balanced armature speaker, comprising:
a motor comprising a coil and a magnet assembly;
an armature extending through said coil and said magnet assembly;
a drive pin having one end coupled to said armature and a second end coupled to a membrane;
a housing containing said motor, said armature, said drive pin and said membrane; and
a spout coupled to a respective end of said housing including a low pass filter.

10. The balanced armature speaker of claim 9, wherein said low pass filter comprises a generally circular shaped aperture aligned with an acoustic output port of said housing.

11. The apparatus of claim 9, further comprising a second motor comprising a second coil and a second magnet assembly; a second armature extending through said second coil and said second magnet assembly; a second drive pin having one end coupled to said second armature and another end coupled to a second membrane; and wherein said second motor, said second armature, said second drive pin, and said second membrane are positioned within said housing.

12. The apparatus of claim 11, wherein said housing includes a first acoustic opening in communication with said low pass acoustic filter and a second acoustic opening sealed apart from said first acoustic opening that is in communication with an acoustic output port of said spout.

13. The apparatus of claim 9, wherein said low pass acoustic filter comprises an aperture in said spout.

14. The apparatus of claim 13, wherein said aperture comprises a generally circular shaped aperture having a predetermined width and diameter.

15. The apparatus of claim 9, wherein said armature is tuned to a low pass frequency response.

16. The apparatus of claim 11, wherein said armature is tuned to a low pass frequency response and said second armature is tuned to a high pass frequency response.

17. An apparatus, comprising:
a first transducer positioned in a housing;
a second transducer positioned in said housing such that said first and second transducers are oriented in a side-by-side relation in said housing;
a dividing member separating said first and second transducers such that said first and second transducers are substantially isolated from one another;
a spout connected to a respective end of said housing;
a first output port in said housing for directing sound waves generated by said first transducer through an output of said spout; and
a second output port in said housing for directing sound waves generated by said second transducer through a low pass filter and then out of said spout.

18. The apparatus of claim 17, wherein said first and second transducers comprise a motor having a coil and a magnet assembly; an armature extending through said coil and said magnet assembly; and a drive pin having one end coupled to said armature and a second end coupled to a membrane.

19. The apparatus of claim 18, wherein said armature associated with said second transducer is tuned to a low pass frequency response.

20. The apparatus of claim 19, wherein said armature associated with said first transducer is tuned to a high pass frequency response.

21. The apparatus of claim 17, wherein said first transducer is tuned to a high frequency response and said second transducer is tuned to a low frequency response.

22. The apparatus of claim 17, wherein said low pass filter comprises an aperture in said spout apart from said output of said spout.

23. A method, comprising:
generating sound waves from a first transducer positioned in a housing;
generating sound waves from a second transducer positioned in said housing;
directing said sound waves generated by said first transducer to an output port located in a spout; and
directing said sounds waves generated by said second transducer to a low pass filter located in said spout.

24. The method of claim 23, wherein said first and second transducers comprise a motor having a coil and a magnet assembly; an armature extending through said coil and said magnet assembly; and a drive pin having one end coupled to said armature and a second end coupled to a membrane.

25. The method of claim 24, where said armature of said first transducer is tuned to a high frequency response.

26. The method of claim 24, wherein said armature of said second transducer is tuned to a low frequency response.

27. The method of claim 23, wherein said first transducer is tuned to a high frequency response and said second transducer is tuned to a low frequency response.

28. An apparatus, comprising:
a housing;
a first motor assembly coupled to a first diaphragm positioned in a first side of said housing;
a second motor assembly coupled to a second diaphragm positioned in a second side of said housing;
a cover separating said first motor assembly and said first diaphragm from said second motor assembly and said second diaphragm;
a first acoustic output port located in said housing for directing sound waves generated from operation of said first diaphragm out of said housing;
a second acoustic output port located in said housing for directing sound waves generated from operation of said second diaphragm out of said housing; and
a filter in communication with said first acoustic output port for attenuating a predetermined range of frequencies from said sound waves generated by operation of said first diaphragm.

29. The apparatus of claim 28, further comprising a spout connected with said housing.

30. The apparatus of claim 29, wherein said filter is located in said spout.

31. The apparatus of claim 30, wherein said acoustic low pass filter comprises a generally circular shaped aperture.

32. The apparatus of claim 28, wherein said first motor assembly includes an armature tuned to a low pass frequency response.

33. The apparatus of claim 32, wherein said second motor assembly includes a second armature tuned to a high pass frequency response.

34. The apparatus of claim 32, wherein said low pass frequency response ranges from about 20 Hertz to 300 Hertz.

35. The apparatus of claim 32, wherein said high pass frequency response ranges from about 300 Hertz to 20,000 Hertz.

36. An in ear audio system, comprising:
an electric audio signal source for producing an electric audio signal;
a crossover connected with said electric audio signal source including a low pass filter and a high pass filter;
a balanced armature speaker connected with a first output of said low pass filter and a second output from said high pass filter; and
wherein said balanced armature speaker includes a motor assembly coupled to a diaphragm; a housing defining an interior chamber, wherein said motor assembly and said diaphragm are positioned within said interior chamber; an acoustic output port located in a respective end of said housing; and a low pass acoustic filter in communication with said acoustic output port operable to attenuate a predetermined range of frequencies from an audio signal produced by said diaphragm.

37. The system of claim 36, wherein said crossover comprises an passive crossover.

38. The system of claim 36, wherein said crossover comprises an active analog crossover.

39. The system of claim 37, wherein said crossover comprises an active digital crossover.

40. The system of claim 39, wherein said active digital crossover comprises a finite impulse response crossover.

41. The system of claim 39, wherein said active digital crossover comprises a infinite impulse response crossover.

42. The system of claim 36, wherein said low pass acoustic filter comprises an aperture formed in said housing.
